(19) United States
(12) Patent Application Publication
(10) Pub. No.: US 2023/0014857 A1
(43) Pub. Date: Jan. 19, 2023

(54) Method and System for Programming a Robot

(71) Applicant: ABB Schweiz AG, Baden (CH)

(72) Inventors: Fan Dai, Ladenburg (DE); Nuo Li, Ladenburg (DE); Marcel Dix, Ladenburg (DE); Dongliang Cao, Ladenburg (DE)

(73) Assignee: ABB Schweiz AG, Baden (CH)

(21) Appl. No.: 17/952,987

(22) Filed: Sep. 26, 2022

Related U.S. Application Data
(63) Continuation of application No. PCT/EP2020/058868, filed on Mar. 27, 2020.

(51) Int. Cl. B25J 9/16; G06F 3/0486; G06F 3/04815

(52) U.S. Cl. CPC B25J 9/1671; B25J 9/1664; G06F 3/0486; G06F 3/04815

(57) ABSTRACT

A system and method for programming a robot includes providing a 3D representation of workpieces to be handled by the robot, and of a working environment; synthesizing and displaying a view of the working environment comprising an image of the workpieces at respective initial positions; identifying matching features of the selected workpiece and of the working environment which are able to cooperate to hold the workpiece in a final position in the working environment, and a skill by which the matching features can be brought to cooperate; identifying an intermediate position from where applying the skill to the workpiece moves the workpiece to the final position; and adding to a motion program for the robot a routine for moving the workpiece from its initial position to the intermediate position and for applying the skill to the workpiece at the intermediate position.

### CROSS-REFERENCE TO RELATED APPLICATIONS

This patent application claims priority to International Patent Application No. PCT/EP2020/058868, filed on Mar. 27, 2020, which is incorporated herein in its entirety by reference.

### FIELD OF THE DISCLOSURE

The present disclosure relates to a system and method for programming a robot.

### BACKGROUND OF THE INVENTION

Programming an industrial robot is a time-consuming task, especially for applications where several workpieces have to be assembled into a product.

Conventional CAD tools can provide very detailed information about workpieces that are to be assembled into a given product, but, due to the large variety of geometric features of different workpieces that might have to engage with each other in an assembly process, of CAD data formats, and of unknown-parameters such as material properties, design tolerances etc. there is currently no system capable of deriving an assembly program for a robot directly from CAD data of the workpieces to be assembled.

In the automation industry, there are various software products to support programming industrial robots such as ABB PowerPac. Such software can assist the user to define workspaces, work objects, and focuses on automatically generating paths for a robot processing a single stationary workpiece, e.g. by machining or welding, but provides only limited support for assembly processes that involve displacing workpieces.

### BRIEF SUMMARY OF THE INVENTION

In one aspect, the present disclosure describes a method that facilitates programming of assembly tasks to be carried out by a robot.

In one embodiment, the method for programming a robot comprising the steps of:

a) providing a 3D representation of at least one workpiece to be handled by the robot,
b) providing a 3D representation of a working environment comprising an initial position where the workpiece is to be seized by the robot, and a final position where the workpiece is to be installed by the robot;
c) synthesizing and displaying a view of the working environment comprising an image of the workpieces at respective initial positions;
d) enabling a user to select one of the displayed workpieces;
e) identifying matching features of the selected workpiece and of the working environment which are able to cooperate to hold the workpiece in a final position in the working environment, and a skill by which the matching features can be brought to cooperate;
f) based on the skill and on the final position, identifying an intermediate position from where applying the skill to the workpiece moves the workpiece to the final position; and
g) adding to a motion program for the robot a routine for moving the workpiece from its initial position to the intermediate position and for applying the skill to the workpiece at the intermediate position.

### BRIEF DESCRIPTION OF THE SEVERAL VIEWS OF THE DRAWING(S)

FIG. 1 is a block diagram of a computer system in accordance with the disclosure.

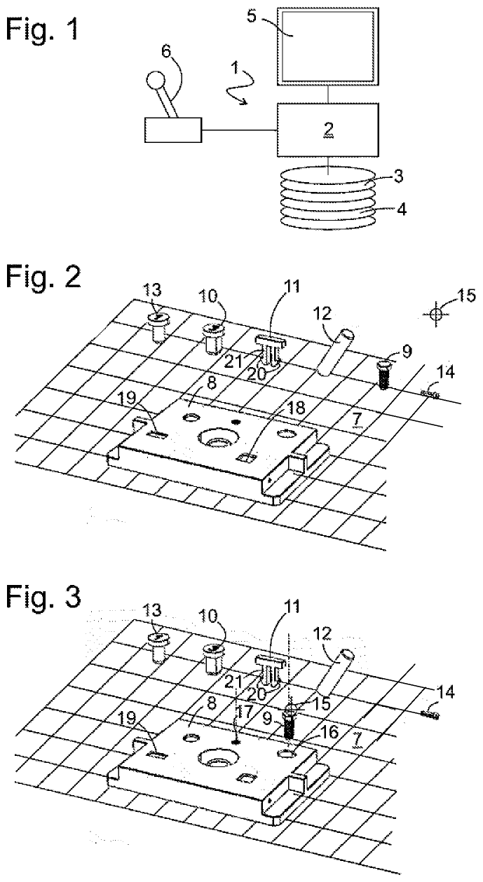

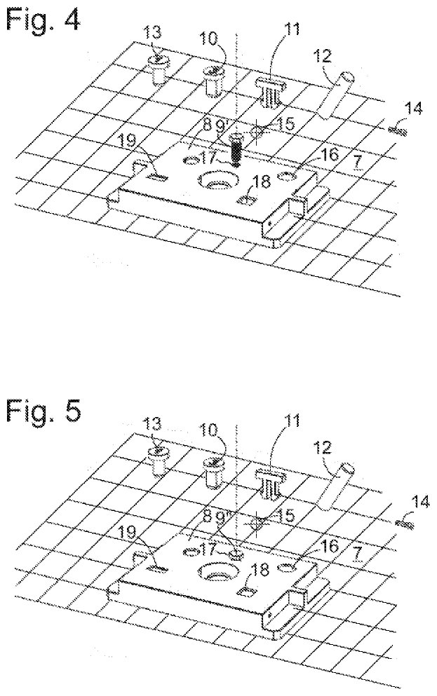

Each of FIGS. 2, 3, 4, and 5 is a view of a working environment generated by the computer system in the process of carrying out the method in accordance with the disclosure.

### DETAILED DESCRIPTION OF THE INVENTION

The computer system of the present disclosure comprises a general purpose computer 1 having a CPU 2, program and data storage 3, 4, a display 5 and a coordinate input device 6. Program storage 3 holds a program whose instructions enable the computer to carry out the method described below. Data storage holds 3D representations, typically CAD data, of an initial working environment, of a product to be assembled and of the workpieces to be assembled into the product. These representations comprise all data that are needed for generating a realistic or at least unambiguously recognizable image of each workpiece on display 5. They further comprise detailed information on features of the workpieces, by which these are to be connected to the environment or to each other, by which the computer can judge whether two such features can be connected to each other or not. A robot for which the system is to generate a program that will enable the robot to assemble the physical workpieces doesn't have to be part of the system.

In an elementary case, the initial working environment is a solid surface 7 such as a tabletop, and in a first step of the method, a first workpiece 8 is virtually fixed on said surface by the computer 1, whereby a secondary working environment is obtained. The computer 1 synthesizes a view of this secondary working environment and of some workpieces 9-14 that are not yet installed, as shown in FIG. 2, and shows it on display 5.

In this view, some of the virtual workpieces 9-14 are shown in an orientation in which their physical counterparts wouldn't be stable on the surface of the working environment. The reason is that the computer 1 derives from the 3D representation of the product to be assembled the orientation the workpieces 9-14 are going to have in this product, and displays them in this orientation. In this way, the way in which the workpieces might be installed is easier for a user to recognize from the view.

For a human user, it is readily apparent that the workpieces 9-14 are of different types and will have to be joined to the workpiece 8 by different skills. In the present example, workpiece 8 has matching features for each one of workpieces 9-14; in a more complex scenario, there might be uninstalled workpieces for which there is no matching feature yet in the working environment, but will be formed in the process of installing other workpieces only; in that case there will be workpieces in the view which cannot yet be installed, and the user has to select a workpiece which can.

For the assembly of a product, several workpieces of a same type, e.g., screws, may be required. In that case, several positions will be available in the working environment where a screw can be installed, but the computer 1 as a rule has no criteria by which to decide where a particular screw should go. This decision should be made by the user and input into the computer system as will be de-scribed below.

In the illustrated example, workpiece 9 is a screw. The computer 1 can be made aware of the fact if, in the 3D representation mentioned above, the workpiece is explicitly labeled as a screw. Alternatively, the computer might be programmed to identify workpiece 9 as a screw based on its geometrical characteristics. Further alternatively, the information that workpiece 9 is a screw may be input by the user, for example when selecting it or in a preliminary step in which all workpieces 9-14 are successively characterized.

The user selects workpiece 9 in the usual way by placing a cursor 15 on it in the view on display 5, using coordinate input device 6, and pressing a key. When the workpiece 9 is selected, the image of the workpiece 9 will move as if attached to the cursor 15 when the user moves the cursor 15 further.

The coordinate input device 6 might be a 3D input device, colloquially referred to as a “space mouse” by which not only a coordinate triplet but also orientation angles of the workpiece in a coordinate system of the working environment can be specified. Preferably, simpler and cheaper input devices are used. For example, in the present case, means for specifying orientation angles can be dispensed with, either because the orientation of the workpieces displayed in the view doesn't have to be changed, or because, if a rotation should become necessary, the computer determines the rotation without requiring input from the user. Further, inputting merely two space coordinates can be sufficient, since the computer 1 can choose the third coordinate so that the workpiece is located immediately adjacent to a surface of the working environment that is shown in the view.

Suppose the user drags the screw towards a hole 16 of workpiece 8 (FIG. 3) using coordinate input device 6. Based on the 3D representation, the computer 1 checks whether the screw would fit in hole 16. In the affirmative, the user is made aware of the fact by, e.g., the image of the screw flashing, changing its color, or the like. If the user is aware that the screw 9 isn't supposed to go into hole 16, he will drag the screw further, and the image of the screw changes back to normal.

When the screw 9 is moved to the vicinity of hole, the system again detects that the screw might fit, and makes the user aware thereof. The user confirms that the screw 9 is to go into hole 17, e.g., by releasing or by pressing once more the key used earlier for selecting the workpiece.

Insertion of the physical screw 9 in hole 17 would require a screwing action by the robot. Based on the coordinates of the hole 17, the computer 1 calculates an intermediate position 9′ (FIG. 4) from which the screw can be inserted in the hole 17, i.e., a position close to the surface of workpiece 8 in which axes of the screw 9 and of the hole 17 are aligned. Then, it calculates a routine by which the robot can first move the physical screw from its initial position to said intermediate position adjacent the workpiece 8, and from there screw it in, and appends it to the working program for the robot.

The position in the vicinity of hole 17 where the user has dragged the image of the screw and where the computer 1 detects that the screw might fit in hole 17 will generally not be identical to the above-mentioned intermediate position. Therefore, for making the user aware of a possible fit, the computer 1 can, in addition or as an alternative to the methods mentioned above, abruptly move the image of the screw (or any other workpiece which happens to be selected) from the position set by the user to the intermediate position 9′. Since the screw is thus moved with respect to the cursor 15—in FIG. 4 it is actually detached from the cursor 15—the user cannot fail to notice the displacement, even if small.

When the virtual screw 9 has been inserted in hole 17, thus reaching its final position 9″ shown in FIG. 5, the hole 17 is no longer available for inserting a workpiece therein, and the presence of the head of the screw outside the hole 17 may have an influence on how other workpieces can be approached to the workpiece 8 and connected to others of its features. Therefore, a new secondary working environment is calculated which comprises not only workpiece 8, but also screw 9, and which will be used for processing the next workpiece selected by the user.

Workpiece 10 is a rectangular plug. Once this fact is recognized by the system, based on the stored 3D representation or from input by the user, the computer 1 begins to search the working environment for an appropriate socket. The process may be speeded up by the user selecting workpiece 10 and dragging it towards socket 18, thereby indicating to the computer 1 a region of the working environment where the final position of workpiece 10 might be found, and where a search for this final position should best begin. When the match between workpiece 10 and its associated feature, such as socket 18, in the working environment is recognized, the computer 1 autonomously calculates an intermediate position adjacent to the socket 18 in which longitudinal axes of the plug and the socket 18 are aligned, so that from the intermediate position the physical plug can be pressed into its final position in the socket 18 of physical workpiece 8 by a linear displacement of the robot, and the computer 1 places the image of workpiece 10 in said intermediate position in the view shown on display 5, so as to make the user aware of the match.

Based on the 3D representation, the computer 1 may be able to identify the position where a workpiece has to be installed in a very short time, or may even have identified it before the user has selected the workpiece. This is possible in particular if a workpiece, such as the plug, occurs just once in the product to be assembled. In such a case, the computer will move the image of the workpiece to its intermediate or final location in the very moment the workpiece is selected by the user.

Workpiece 11 is a clip. A human user will readily recognize that, of all features of workpiece 8, the clip can only go into hole 19. A computer will a priori not do so, for if only geometrical features are compared, it will regard the barbs 20 of the clip 11 as not fitting into hole 19. Here, explicitly labeling the workpiece 11 as an elastic clip, be it by a label included in the 3D representation or by user input, enables the system to disregard the barbs 20, to realize that a stem 21 of the clip would indeed fit the cross section if the hole 19, and to make the user aware of the fact in any of the ways described above. Based on this information, the system is further able to program the robot so that when the clip is moved from an intermediate position in front of hole 19 to its final position inside the hole, enough pressure is applied to deflect the barbs 20 so that they will enter the hole 19.

Workpiece 13 is a cylindrical rod. Its selection by the user, dragging to and finally inserting it in hole 16, can be carried out according to the principles described above. However, the system cannot judge a priori from the geometrical characteristics of the workpiece 13 whether it is to be immobile after installation, or whether it is to be rotatably mounted. Again, such information has to be provided in the 3D representation of either workpiece 13 or workpiece 8, or to be input by the user. Depending on this information, computer 1 determines whether the robot program for mounting the rod includes a skill of e.g. soldering, ultrasonic or friction welding or the like in addition to that of pushing the rod into the hole 16.

In this method, what the user is required to do is to define the order in which the workpieces are assembled. The tasks of determining a routine by which the robot moves the selected workpiece to the intermediate position and of controlling the skill by which the robot brings it from the intermediate position to the final position can be automatized.

Displaying the currently selected workpiece at the intermediate or final position can be helpful in that it enables the user to check whether the system is planning to install the workpiece at the position where it actually belongs. This is particularly relevant if there are several identical workpieces, and there is a possibility of installing one at a final position where it would block the subsequent installation of other workpieces.

Therefore the method should proceed from step f) to step g) only after approval of the match by a user.

If the method allows the user to drag the image of the workpiece to a desired position, this can help the method to identify a suitable intermediate position, assuming that the user is actually dragging the workpiece towards a position where it should be installed.

On the other hand, if the user drags the workpiece away from an intermediate position where it is currently displayed, it is evident that the user disapproves of this intermediate position and wishes the workpiece to be installed elsewhere.

When a final position has been determined for a first workpiece, the working environment should be updated by including in it the workpiece at its final position. Thus, when a second workpiece is selected by the user, the search for matching features of the second workpiece and of the working environment can automatically disregard the feature occupied by the first workpiece, and calculation of a path by which the robot can move the second workpiece from its initial to its intermediate position can take account of a contour of the working environment modified by addition of the first workpiece.

The 3D representation of the workpiece used for synthesizing the view and for finding matching features is preferably derived in a preparatory step from CAD data of the workpiece.

Finding features of the workpiece that might match features of the working environment can be facilitated if such features are labeled in the CAD data. Such a label may explicitly characterize the feature by the way in which it is supposed to connect to a matching feature of the working environment, or by a reference to a skill by which it is to be connected to its counterpart feature, i.e. by defining the feature to be e.g. a male or female thread, a welding surface, a plug, a socket or the like, or it may simply specify that the feature is expected to connect to some matching feature of the working environment, leaving to the computer system or to a user seeing the feature displayed in the view of the working environment the task of identifying the matching feature and a suitable skill, e.g., based on geometrical characteristics of the feature.

If the CAD data comprise a 3D representation of the product to be assembled from the workpieces, the orientation of the workpieces in the product can be extracted from the CAD data. In that case the user's task can be simplified by displaying to him, in the view of the working environment, all workpieces in the orientation they are going to have in the assembled product.

It should be appreciated that there can be as many different types of matching features as there are skills for joining workpieces, and in principle, the present invention is applicable to any of these. As an illustration, the matching features can be a projection and a recess that are engageable in a given direction. In that case, the associated skill would be pushing the workpiece in the given direction. Optionally, a projection and a recess can be regarded as matching if they have identical cross sections. Alternatively, the matching features can be male and female threads, in which case the associated skill is screwing, or plane surfaces, in which case the associated skill can be gluing, welding or the like.

For a user who sees the workpiece in the synthesized view, a skill by which the workpiece is to be installed in the working environment is often immediately apparent. E.g., when the workpiece is a screw, it is obvious for a human user that it has to be screwed, and the only problem may be, in a complicated environment, to find the correct hole for the screw. Therefore, if the user specifies to the computer system the skill by which the workpiece is to be installed, this greatly reduces the system's choice of candidates for matching features, so that matching pairs of features of the workpiece and the working environment can be found much more quickly.

The invention can also be embodied in a computer system comprising a computer, a display and a coordinate input arrangement, wherein the computer is programmed to carry out the method described above based on user input provided via the coordinate input arrangement, or in a computer program which, when carried out by a computer system, causes the computer system to carry out the method.

### REFERENCE NUMERALS

1 computer
2 CPU
3 data storage
4 data storage
5 display
6 coordinate input device
7 solid surface
8-14 workpiece
15 cursor
16 hole
17 hole
18 socket
19 hole
20 barb
21 stem

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for programming a robot, comprising the steps of:
a) providing a 3D representation of at workpieces to be handled by the robot;
b) providing a 3D representation of a working environment comprising an initial position where each workpiece is to be seized by the robot, and a final position where the workpiece is to be installed by the robot;
c) synthesizing and displaying a view of the working environment comprising an image of the workpieces at respective initial positions;
d) enabling a user to select one of the displayed workpieces as a selected workpiece;
e) identifying matching features of the selected workpiece and of the working environment which are able to cooperate to hold the workpiece in a final position in the working environment, and a skill by which the matching features can be brought to cooperate;
f) based on the skill and on the final position, identifying an intermediate position from where applying the skill to the workpiece moves the workpiece to the final position; and
g) adding to a motion program for the robot a routine for moving the workpiece from its initial position to the intermediate position and for applying the skill to the workpiece at the intermediate position.

2. The method of claim 1, wherein step f) comprises displaying the workpiece at the intermediate position.

3. The method of claim 2, wherein the method proceeds from step f) to step g) only after approval of the match by a user.

4. The method of claim 2, further comprising enabling the user to drag the image of the workpiece to a desired position.

5. The method of claim 4, wherein the match is regarded as disapproved by a user when the user drags the image of the workpiece away from the intermediate position.

6. The method of claim 1, further comprising the step h) updating the working environment by including in the working environment the workpiece at its final position.

7. The method of claim 6, wherein after step h) the method returns to step c).

8. The method of claim 1, comprising the preparatory step of deriving the 3D representation of the workpiece from CAD data.

9. The method of claim 8, wherein features of the workpiece to be matched with a feature of the working environment are identified in said CAD data.

10. The method of claim 8, wherein the CAD data comprise a 3D representation of the product to be assembled from the workpieces, and in step c) each workpiece is displayed in the orientation it has in the product.

11. The method of claim 1, wherein the matching features include at least one of:
a projection and a recess that are engageable in a given direction and have identical cross sections, wherein the associated skill is pushing the workpiece in the given direction;
male and female threads, and the associated skill is screwing; and
plane surfaces, and the associated skill is placing the surfaces in contact, accompanied by pressing and/or heating.

12. The method of claim 1, further comprising a step of identifying matching features of the workpiece and the working environment taking into account a skill specified by the user.

13. A computer system comprising a computer, a display and a coordinate input means, the computer system including tangible and non-transitory computer instructions that, when executed, carry out the following processes:
a) provide a 3D representation of workpieces to be handled by a robot;
b) provide a 3D representation of a working environment comprising an initial position where each workpiece is to be seized by the robot, and a final position where the workpiece is to be installed by the robot;
c) synthesize and display a view of the working environment comprising an image of the workpieces at respective initial positions;
d) enable a user to select one of the displayed workpieces as a selected workpiece;
e) identify matching features of the selected workpiece and of the working environment which are able to cooperate to hold the workpiece in a final position in the working environment, and further identify a skill by which the matching features can be brought to cooperate;
f) based on the skill and on the final position, identify an intermediate position from where applying the skill to the workpiece moves the workpiece to the final position; and
g) add to a motion program for the robot a routine for moving the workpiece from its initial position to the intermediate position and for applying the skill to the workpiece at the intermediate position.
